(19) United States
(12) Patent Application Publication
(10) Pub. No.: US 2024/0033182 A1
(43) Pub. Date: Feb. 1, 2024

(54) COUPLING DEVICE FOR AN ADAPTER FOR A VIAL, ADAPTER FOR A VIAL, SET COMPRISING AN ADAPTER OF THIS TYPE, AND SYSTEM COMPRISING AN ADAPTER OF THIS TYPE

(71) Applicant: B. Braun Melsungen AG, Melsungen (DE)

(72) Inventors: Karl Martin Berg, Melsungen (DE); Florin Kopp, Schortens (DE); Varaprasad Sikhile, Melsungen (DE); Christian Walter, Kassel (DE); Johannes Bolz, Kassel (DE); Konstantin Krug-Sauer, Gudensberg (DE)

(21) Appl. No.: 18/022,318

(22) PCT Filed: Aug. 26, 2021
(86) PCT No.: PCT/EP2021/073628

§ 371 Date: Feb. 21, 2023

(30) Foreign Application Priority Data
Aug. 28, 2020 (DE) 10 2020 210 898.6

(51) Int. Cl. A61J 1/20; A61J 1/14

(52) U.S. Cl. CPC A61J 1/2096; A61J 1/2048; A61J 1/1468; A61J 1/201

(57) ABSTRACT

A coupling device for an adapter for a vial for a medical liquid. The coupling device is configured to connect the adapter to the vial. The coupling device has an elastic structure for adjusting the adapter to accommodate different sizes of the vial.

### CROSS-REFERENCE TO RELATED APPLICATIONS

This application is the United States national stage entry of International Application No. PCT/EP2021/073628, filed Aug. 26, 2021, and claims priority to German Application No. 10 2020 210 898.6, filed Aug. 28, 2020. The contents of International Application No. PCT/EP2021/073628 and German Application No. 10 2020 210 898.6 are incorporated by reference herein in their entireties.

### FIELD

The invention relates to a coupling device for an adapter for a vial for a medical liquid, such an adapter, a set comprising such an adapter and a system comprising such an adapter.

### BACKGROUND

For therapeutic purposes, injections, infusions and other measures for administering a medical liquid are performed in human and veterinary medicine. For example, in the course of an injection, a liquid containing an active substance can be introduced into the bloodstream of a patient. In this case, the liquid to be administered is often taken from a so-called vial using a hypodermic syringe. A vial is a liquid container whose opening is typically sealed with a septum or injection stopper that may be pierced with the hypodermic needle. Therefore, vials are sometimes also referred to as “pierceable injection vials” or just “injection vials”. The terms “flacon”, “phial” etc. are also used for vials if confusion with other types of ampoules and phials is excluded.

The liquid container of a vial is made of glass or plastic, for example. Its capacity may contain, for example, a single dose or several single doses of the liquid to be administered.

Vials are also filled with dry substance, as some medicinal substances are not sufficiently stable in a dissolved state. The dry substance is dissolved in a solvent (e.g. water or sodium chloride solution) added to the vial before injection. The solution is then removed from the vial in the manner described above.

Vials also have many uses in the laboratory, especially in the field of biotechnology, for manipulating liquids.

As an alternative to the described procedure of piercing the septum or stopper with the hypodermic needle and withdrawing an injection dose of the liquid from the vial using the hypodermic syringe connected to the hypodermic needle, an adapter for the vial can be used. Connecting the adapter to the vial establishes a fluid connection to the interior of the vial, for example, by means of a hollow spike (i.e. a hollow mandrel) or the like that is pierced through the septum.

The adapter has a fluid connector that is in fluid communication with the hollow spike and through which a liquid can be withdrawn from the vial or a liquid can be added to the vial. The fluid connector may be, for example, a port for a plug connection, such as a port for a Luer connection. Herein, the connector preferably has a female Luer cone, as hypodermic syringes and other liquid withdrawal devices typically have a male Luer cone. The Luer connector may be of the “Luer-slip” or “Luer-lock” type. The fluid connector may also be, for example, a connector having a different type of coupling element.

Accordingly, the adapter may be considered as a transfer device for a medical liquid. For example, the adapter may be a transfer device according to the ISO 22413:2010 standard.

The use of an adapter has some distinct advantages. When a liquid is withdrawn from or added to the vial by means of a hypodermic syringe equipped with a hypodermic needle, the septum of the vial does not need to be pierced separately. Piercing the septum of the vial is prone to errors, in particular it is often not performed at the correct angle, and is associated with a risk of puncture injuries. The use of an adapter in this context is particularly advantageous if—without using the adapter—the septum would have to be pierced several times.

Furthermore, the fluid connector may be designed in such a way that connecting to a syringe or other device for withdrawing or adding a liquid is easier, less error-prone and less likely to cause injury than piercing a septum with a needle. To this end, the fluid connector may, for example, be in the form of a plug connector, such as a female Luer connector.

Furthermore, the fluid connector may be configured in such a way that the connection to a syringe or other device for withdrawing or adding a liquid is safer than the connection via a needle inserted into a septum, which could easily be pulled out again unintentionally. For this purpose, the fluid connector may, for example, be equipped with force-fit and/or form-fit retaining means.

Furthermore, the adapter offers the possibility of providing a specific connection element for the respective application. For example, with some medicinal substances, contamination of the environment must be avoided because contact of the medical staff or other persons with these substances is risky. This is the case, for example, with some cytostatic drugs that are carcinogenic or mutagenic. The handling of such drugs is therefore preferably carried out in closed systems by means of so-called “closed system transfer devices” (CSTD). The adapter may have a connection structure suitable for this purpose.

Another application where the use of an adapter is advantageous or even necessary is the transfer of a liquid between a vial and a fluid device, for example another liquid container, such as a container for an infusion solution. In such cases, it may be particularly advantageous if an adapter suitable or specially designed for the fluid device is traded as an accessory together with the fluid device.

In the prior art, adapters are known which can be irreversibly connected to the vials. An “irreversible connection” is understood to be a connection between two objects which cannot be released, at least not without applying high forces or damaging or destroying one of the objects.

Each of these adapters is designed for a specific size of vial and can only be used with vials of that size. Vials typically conform to ISO 8362-1 and ISO 8536-1 standards. The diameter of the neck of the vials of the various sizes is 13 mm, 20 mm, 28 mm and 32 mm (each within certain tolerances), wherein of the two largest diameters mentioned, one is commonly used in Europe (32 mm) and the other, e.g., in the USA (28 mm).

One difficulty that arises in connection with the use of vial adapters is that the right adapter must always be available for the respective size.

Furthermore, there is a risk of confusion.

Since vials of different sizes are used in a hospital or comparable facility, various individual items (so-called “stock keeping units”) have to be kept in stock, inventoried, and reordered as needed. This results in a high administrative effort and a large space requirement. To solve this problem, sets of adapters for different sizes are also offered in a common packaging. The disadvantage of this approach is that usually only one adapter of a certain size is needed at a time. The other adapters that are unused must then be disposed of as waste, which is economically and ecologically unfavourable.

There is also an adapter for 20 mm vials on the market that comes with an additional plug-in ring that can be connected to the neck of a 13 mm vial to make it suitable for the 20 mm adapter. However, the ring is again an additional component that is discarded unused as waste when the adapter is used with a 20 mm vial. In addition, the use of the ring is error-prone and time-consuming.

Moreover, the known adapters cannot be used for vials whose size deviates from the standard sizes mentioned.

### SUMMARY

Based on the above situation, one task of the invention is to provide a coupling device for an adapter for a vial for a medical liquid, with which the adapter can be improved, in particular made more universally usable.

The coupling device according to the invention is a coupling device for an adapter for a vial for a medical liquid. The coupling device is configured to connect the adapter to the vial. The coupling device comprises an elastic structure for adjusting the adapter to different sizes of the vial.

Typically, in addition to a coupling device configured to connect the vial to the adapter, an adapter comprises at least the following further devices:
a vial connector configured to provide fluid communication between an interior of the vial connected to the adapter and the adapter, and
a fluid connector configured to provide a fluid connection between a fluid device and the adapter such that a fluid connection is provided between the interior of the vial connected to the adapter and the fluid device.

The coupling device comprises an elastic structure for adjusting the coupling device, and thus the adapter as a whole, to different sizes of vial.

Preferably, the coupling device comprises a base body having an opening for receiving the vial, in particular a portion of the neck of the vial. For example, the elastic structure is connected to or integrally formed with the base body.

The adjustment to the size of the vial is preferably performed by a deformation or deflection of the elastic structure or a part of the elastic structure depending on the size of the respective vial. Herein, the deformation or deflection is greater when connected to a larger vial than when connected to a smaller vial.

Since vials typically have a round cross-section, the size of the vial to which the adjustment by the elastic structure occurs is preferably the diameter of the neck of the vial.

Typically, the adjustment can only take place in a certain range of the size of the vial, i.e. vials of a smallest possible size (for example neck diameter d=dₘᵢₙ) and vials of a largest possible size (for example neck diameter d=dₘₐₓ) as well as vials with a size in between (for example neck diameter d: dₘᵢₙ≤d≤dₘₐₓ) can be connected to the adapter. Preferably, the width of the range (for example dₘₐₓ−dₘᵢₙ) is at least 12%, more preferably at least 25%, even more preferably at least 50% of the smallest possible size (for example dₘₐₓ≥1.12×dₘᵢₙ or dₘₐₓ≥1.25×dₘᵢₙ or dₘₐₓ≥1.50×dₘᵢₙ). Alternatively, the width of the region is preferably at least 2 mm, more preferably at least 3 mm, even more preferably at least 6 mm (for example dₘₐₓ≥2 mm+dₘᵢₙ or dₘₐₓ≥3 mm+dₘᵢₙ or dₘₐₓ≥6 mm+dₘᵢₙ).

The expression according to which the adapter is an “adapter for a vial” means in particular that the adapter is intended to be connected to a vial.

By the expression according to which the vial is a “vial for a medical liquid”, it is expressed in particular that the vial contains a medical liquid (water, aqueous solution, medical sample, etc.) or that a medical liquid is receivable therein.

The adapter according to the invention is an adapter for a vial for a medical liquid, comprising:
a coupling device according to the invention,
a vial connector configured to provide fluid communication between an interior of the vial connected to the adapter and the adapter, and
a fluid connector configured to provide a fluid connection between a fluid device and the adapter such that a fluid connection is provided between the interior of the vial connected to the adapter and the fluid device.

The set according to the invention is a set comprising:
a first adapter according to the invention; and
a second adapter for a vial for a medical liquid,
wherein the first and second adapters are configured for different sizes or ranges of sizes of vials,
wherein preferably also the second adapter is like the first adapter and the different sizes of the vial to which the coupling device of the first adapter is adjustable are at least partially different from the different sizes of the vial to which the coupling device of the second adapter is adjustable.

The system according to the invention is a system comprising:
an adapter according to the invention and
a fluid device, preferably a container for a medical liquid, more preferably a container containing a medical liquid.

The vial and the fluid device (e.g. a hypodermic syringe) are not considered to be part of the adapter or of the coupling device in the context of this patent application.

### BRIEF DESCRIPTION OF THE DRAWINGS

Further features, expediencies and advantages of the invention are described below by means of exemplary embodiments with reference to the attached figures.

Where directions and orientations are referred to as “upper”/“above”/“top” and “lower”/“below”/“bottom” in the context of the coupling device or adapter in this patent application, they refer to the operating position of the adapter connected to a vial, where the direction from the bottom to the neck of the vial is the bottom-up or vertical direction. A lateral or horizontal direction is a direction across.

FIG. 1 to FIG. 4 show partial longitudinal sections of typical vials with sizes (neck diameters) 13, 20, 28 and 32 mm with dimensions in millimetres.

FIG. 5 shows an adapter with a coupling device according to a first embodiment of the invention, which is connected to a vial of a first size, viewed in longitudinal section in a first lateral direction.

FIG. 6 shows the adapter with the coupling device according to the first embodiment of the invention, which is connected to the vial of the first size, in a perspective view in a second lateral direction, which is rotated by 90° with respect to the first lateral direction according to FIG. 5.

FIG. 7 shows the coupling device according to the first embodiment in a perspective view from diagonally above.

FIG. 8 shows the coupling device according to the first embodiment in a perspective view from diagonally below.

FIG. 9 shows the coupling device according to the first embodiment in a perspective view in lateral direction.

FIG. 10 shows the coupling device according to the first embodiment in a perspective view from above.

FIG. 11A to FIG. 11C show a comparison of the situation depicted in FIG. 5 (FIG. 11A), the adapter with the coupling device according to the first embodiment of the invention, which is connected to a vial of a larger size than in FIG. 5 (FIG. 11C), and an overlay of the state of the adapter of FIG. 11A and the vial of FIG. 11C.

FIG. 12A and FIG. 12B show two adapters with coupling devices according to the first embodiment, which are connected to vials of different sizes.

FIG. 13 shows a coupling device according to a second embodiment in a perspective view from above.

FIG. 14 shows a coupling device according to a third embodiment of the invention in a perspective view from diagonally above.

FIG. 15 shows the coupling device according to the third embodiment of the invention and a vial in a perspective view in lateral direction.

FIG. 16A and FIG. 16B show a comparison of the adapter with the coupling device according to the third embodiment of the invention, which is connected to a smaller vial (FIG. 16A) and a larger vial (FIG. 16B), respectively, as a cross-section through the coupling device and as a longitudinal section.

FIG. 17A and FIG. 17B show cross-sectional views of the coupling device according to the third embodiment in two different sizes.

FIG. 18A and FIG. 18B show perspective views of the coupling device according to the third embodiment in two different sizes from diagonally above.

FIG. 19 shows an adapter with a coupling device according to a fourth embodiment of the invention, which is connected to a vial, in perspective view in lateral direction.

FIG. 20A and FIG. 20B show longitudinal sectional views of the adapter with the coupling device according to the fourth embodiment, which is connected to vials of two different sizes.

### DETAILED DESCRIPTION

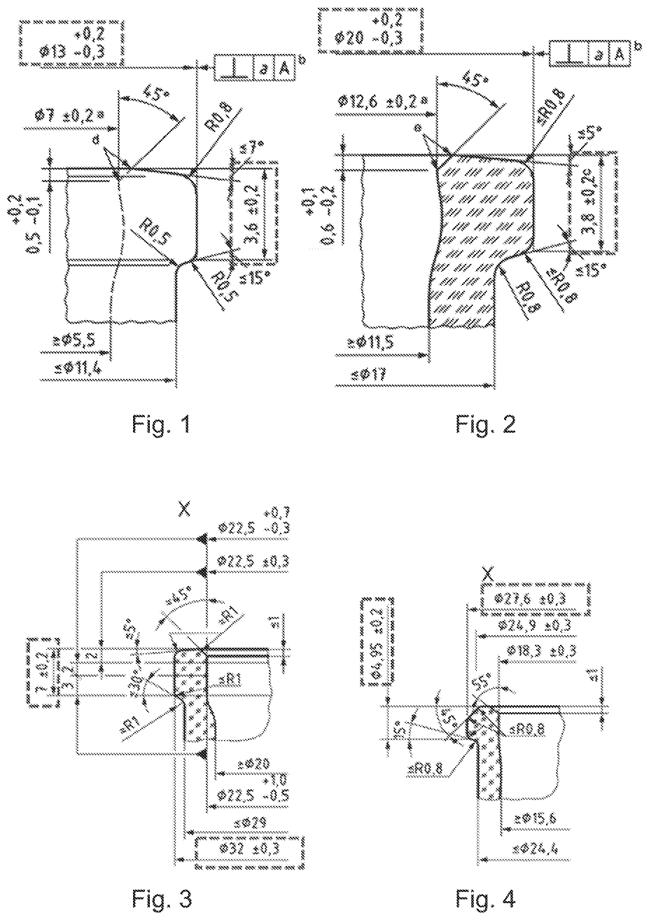

FIG. 1 to FIG. 4 show the size ratios of typical vials, in particular those corresponding to the ISO 8362-1 standard or the ISO 8536-1 standard, as well as the typical manufacturing tolerances.

When in the context of this patent application reference is made to a vial of a particular size, for example a “13 mm vial” or equivalently “vial with diameter 13 mm” or “vial with neck diameter 13 mm” or “vial with size 13 mm” or analogous designations, this refers to a vial with the nominal size indicated, wherein tolerances of the order of magnitude shown in FIGS. 1 to 4 may occur.

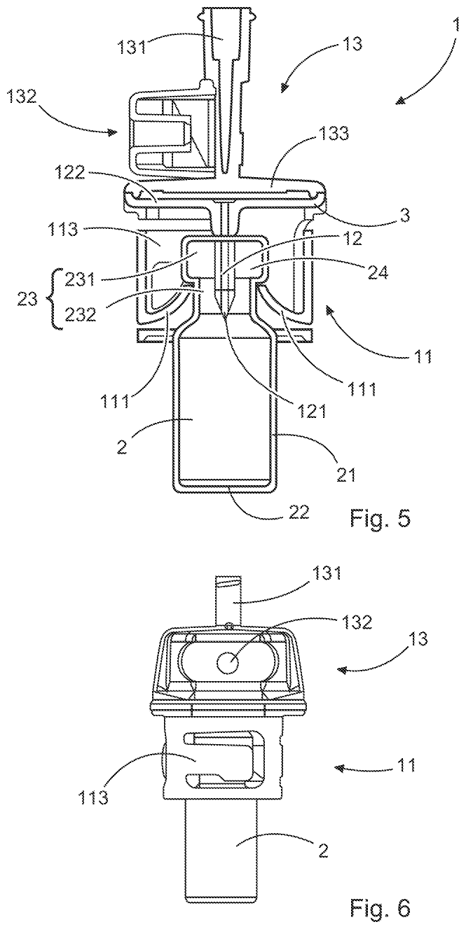

FIGS. 5 and 6 show an adapter 1 with a coupling device 11 according to a first embodiment of the invention. The entire object shown in FIGS. 5 and 6 may thus also be understood as an embodiment of the adapter according to the invention.

Herein, the coupling device 11 or the adapter 1 is shown in an operational state in which the adapter 1 is connected to a vial 2 having a circular cross-section. The vial 2 is not a component of the adapter 1. The vial 2 comprises a container body 21 with a container bottom 22. The vial 2 further comprises a neck 23. The neck 23 comprises an upper neck portion 231 forming the upper portion of the vial 2, and a narrowed portion 232 having a smaller diameter than the upper neck portion 231. When reference is made to the “diameter of the neck” or the “diameter of the vial” in this patent application, this refers to the diameter of the upper neck portion 231. The diameter of the container body 21 may differ from the diameter of the upper neck portion 231. At least in the upper neck portion 231, a septum 24 is provided to seal the vial 2 tightly. A fastening structure may be provided for fastening the septum 24, for example in the form of a metal ring which is placed around the upper neck portion 231 in a form-fit manner and has an opening for an instrument for piercing the septum. As an alternative to a septum 24, the vial 2 may also be closed with an injection stopper (not shown in FIGS. 5 and 6). Alternatively, other pierceable closures are possible. The closure does not necessarily have to seal tightly when an instrument with which it has been pierced to establish a fluid connection is withdrawn again. In particular, this is not necessary if the adapter 1 is configured to be irreversibly connected to the vial 2, i.e. can only be detached from the vial 2 again by applying high force and/or only by destroying the adapter 1 or the vial 2.

In the first embodiment, the coupling device 11 is configured to be connected to a vial 2 having a circular cross-section. Vials with a different cross-section, for example with an oval cross-section, are at least conceivable. Correspondingly, according to further embodiments not shown in the figures, the coupling device 11 is configured to be connected to vials having a non-circular cross-section.

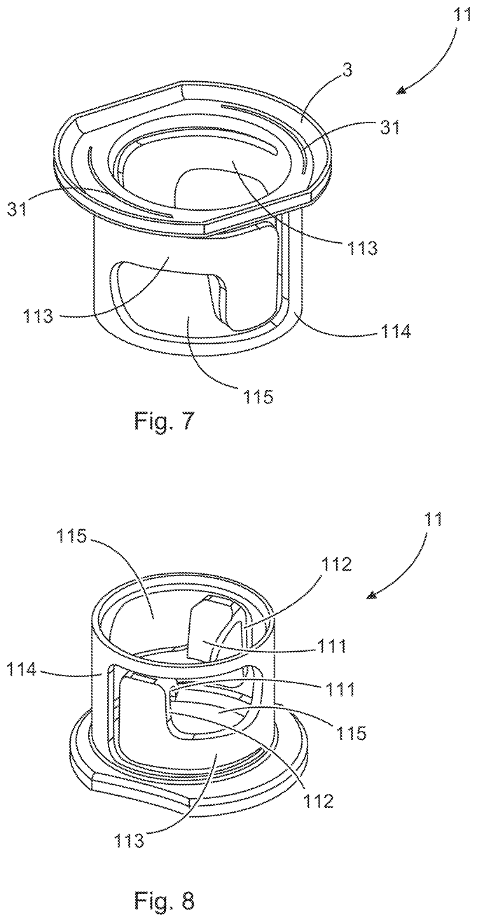

In FIGS. 7 to 10, the coupling device 11 according to the first embodiment of the invention is shown in detail in various views.

In FIG. 7, an optional connection surface 3 for connecting the coupling device 11 to the further components of the adapter 1, preferably by ultrasonic welding, is also shown. The connection surface 3 has optional energy conducting elements 31 to facilitate ultrasonic welding.

The coupling device 11 comprises snap hooks 111 as an engagement structure which, when the vial 2 is connected to the coupling device 11 or the adapter 1, locks onto the vial 2 by sliding the snap hooks 111 along the upper portion 231 of the neck 23 of the vial 2 until they have been advanced to the narrowed portion 232. The snap hooks 111 then engage in the narrowed portion. This situation is illustrated in FIG. 5. The snap hooks may alternatively be referred to as “latching hooks” or the like.

Preferably, the engagement structure irreversibly engages the vial. Alternatively, the engagement structure may be configured to be releasable, for example by the application of a release force or by actuation of a release element by which the engagement structure can be released.

In other embodiments not shown in the figures, only one snap hook is provided. In still other embodiments not shown in the figures, more than two snap hooks 111 are provided. However, two or three snap hooks have proven to be a good compromise between complexity of the design and strength of the engagement connection.

In other embodiments not shown in the figures, the engagement structure is provided by other structures alternatively or in addition to the at least one snap hook, for example by at least one snap projection (“snap lug”) or at least one snap bead.

The engagement structure or the elastic component thereof represents a preferred example of an elastic element, which is also referred to hereinafter as a “second elastic element”. The second elastic element is connected to another elastic element (hereinafter also referred to as “first elastic element”) and together with the latter forms the elastic structure for adjusting the coupling device 11 to different sizes of the vial 2.

By connecting the first elastic element and the second elastic element, i.e. by coupling two elastic elements, an advantageous structure is provided with which, in particular, on the one hand adjustment to different sizes of the vial is possible and with which, on the other hand, secure holding of the vial is possible over a wide range of different sizes of the vial. In particular, the second elastic element can fulfil its function unchanged at different deflections of the first elastic element (i.e. at different sizes of the vial). Herein, further preferably, the direction of deformation of the first elastic member to adjust to different sizes of vials is different from the direction of deformation of the second elastic member.

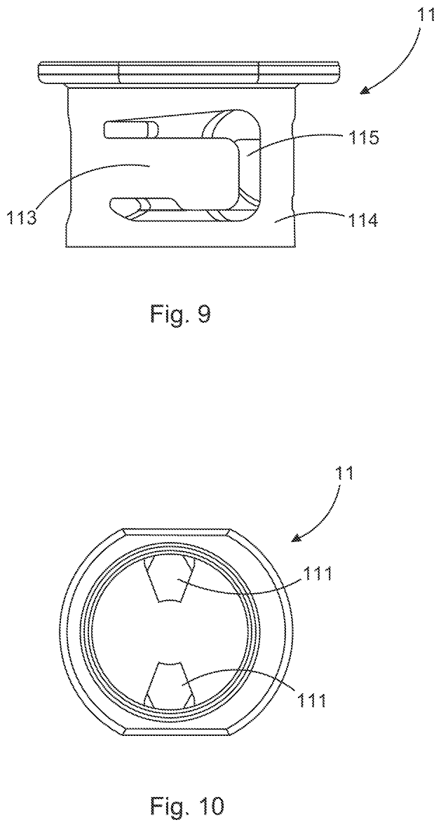

The snap hooks 111 or other engagement structures are optionally each connected to the first elastic element 113, which is described in detail below, via a cantilever 112 (as shown in FIGS. 7 and 8). The cantilever 112 may be elastic and thus contribute to the elastic action of the first elastic element 113 and/or the second elastic element 111. Alternatively, the snap hooks 111 or other engagement structures are arranged directly on a respective first elastic element 113 (as shown in FIGS. 6 and 9).

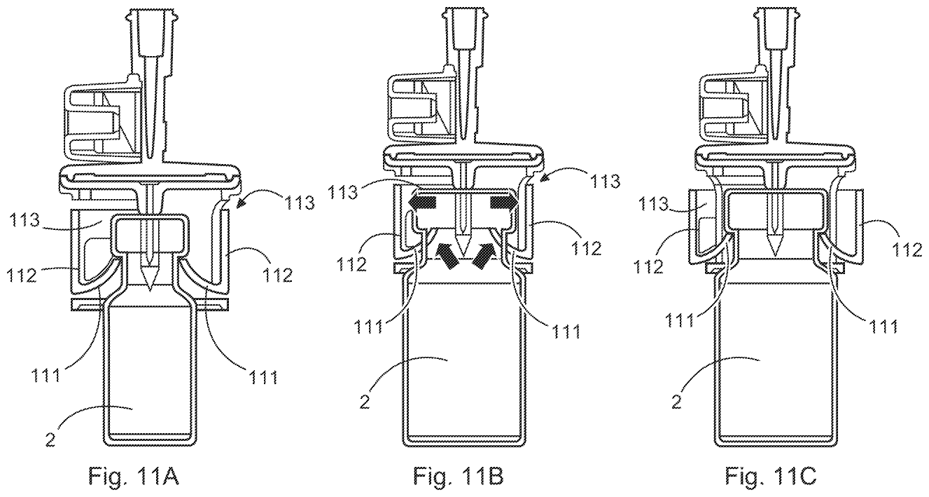

The function of the first elastic element 113 or the first elastic elements 113 is illustrated in FIGS. 11A to 11C.

FIG. 11A corresponds to the situation shown in FIG. 5, in which the snap hooks 111 engage in the narrowed portion 232 of the vial 2, which has a certain diameter.

FIG. 11B does not correspond to a real situation, but only serves to illustrate the function of the first elastic elements 113. The adapter 1 shown in FIG. 11B is in the same condition as the adapter 1 shown in FIG. 11A. However, the neck 23 of the vial 2 shown in FIG. 11B has a larger diameter. Accordingly, the neck 23 cannot be inserted into the coupling device. This is illustrated in FIG. 11B by the overlap of the snap hooks 111 with areas of the vial 2, which is not possible in reality. This problem occurs with conventional adapters when the vial is too large to be connected to the adapter.

In contrast, according to the invention, when a larger vial neck 23 is inserted, the first elastic elements 113 (or the first elastic element 113 if only one is provided) deform such that the larger vial neck 23 can be inserted and the snap hooks 111 snap into the narrowed portion 232. This situation is illustrated in FIG. 11C. The force components that lead to the deformation of the first elastic elements 113 are symbolised by horizontal arrows in FIG. 11B. The force components that lead to the deformation of the snap hooks 111 when connecting adapter 1 and vial 2 and thus deform the second elastic elements are symbolised in FIG. 11B by diagonal arrows. These forces may be transmitted to the components of the coupling device 11 by the snap hooks 111 sliding on the upper portion 231 of the neck 23 of the vial 2 when the vial 2 is inserted into the coupling device 11.

In particular, FIGS. 6 to 9 show how the first elastic elements 113 may be specifically configured. The coupling device 11 comprises a wall 114, inside which the neck 23 of the vial 2 is to be inserted. Clearances 115 are provided in the wall 114, such that remaining wall sections form the first elastic elements 113 and optionally the cantilever arms 112. In the configuration shown in FIGS. 6 to 9, these wall sections represent curved flat springs. In other embodiments not shown in the figures, the at least one first elastic element is configured in other ways, for example as elements attached to the wall or the base body of the coupling device 11.

The number of clearances 115 (one or more) and their shape are chosen such that the first elastic elements 113 have the desired elastic properties.

In the first embodiment, two or three resilient elements are coupled to each other: the snap hooks 111, optionally the cantilevers 112 and the first resilient elements 113. The spring constants are selected or matched to each other in such a way that the individual resilient elements fulfil their described function. In the embodiment, the adjustability to different sizes of the vial according to the invention would not be realisable without the first elastic elements 113.

In alternative embodiments, which are otherwise analogously constructed to the first embodiment, the snap hooks 111 and the optional cantilever arms 112 have a substantially higher spring constant than the first elastic elements 113, or the snap hooks 111 and the optional cantilevers 112 are not designed as spring elements, i.e. they are substantially not deflected or deformed by the forces occurring during use of the adapter 1. In this case, the spring action required to engage the snap hooks 111 is provided at least to a substantial extent by the first elastic elements 113. In the latter case, the elastic structure is therefore formed only by the first elastic elements 113, since there are no second elastic elements.

In the described manner, the adjustment of the coupling device 11 and thus of the adapter 1 to vials 2 with different neck diameters is achieved. The range of different neck diameters to which adjustment is possible may herein include all common neck diameters (typically 13 to 32 mm). This has the advantage that one adapter 1 may be used for all common vials 2.

However, it is also possible to provide adjustability only for a smaller range of neck diameters, for example such that one adapter 1 is suitable for neck diameters from 13 to 20 mm, while for larger neck diameters at least one further adapter is required, which in turn may be adjustable to different neck diameters. There may be several reasons for this: On the one hand, an adapter that is wide enough to be connected to a vial with a neck diameter of 28 mm or even 32 mm would be relatively bulky as an adapter for a vial with a neck diameter of 13 mm. On the other hand, often only vials with two different neck diameters are in use in one and the same workroom, such that adjustability to other vials is not needed at all. In addition, the wider the range in which adjustability is possible, the greater the demands on the elastic elements.

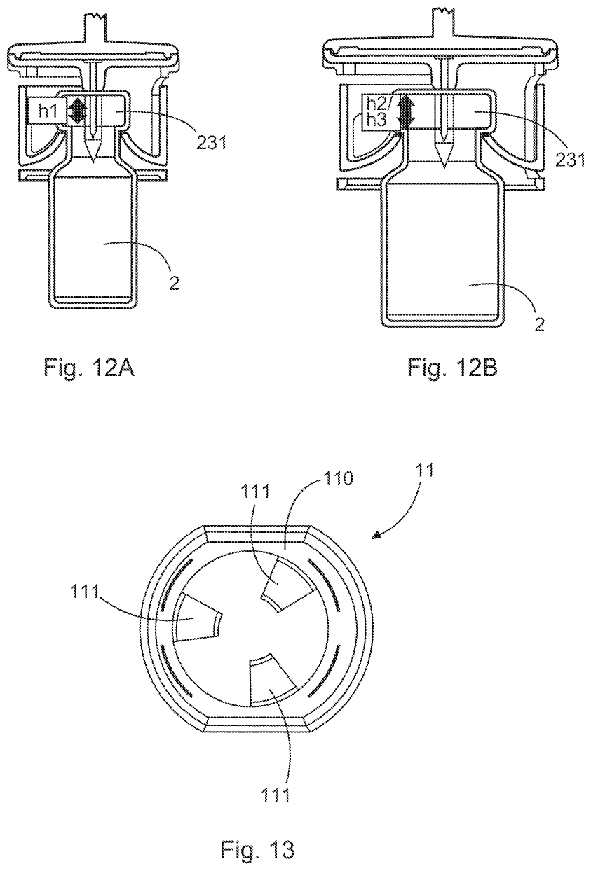

Another reason is that the upper section 231 is generally higher in the case of larger vials 2 than in the case of smaller vials 2. From the dimensions given in FIGS. 1 to 4, it can be seen that the upper portion 231 of common vials 2 (in particular standard vials) with a neck diameter of 13 and 20 mm have a height of 3.6 to 3.8 mm (collectively referred to as height h1), while the upper portion 231 of common vials 2 (in particular standard vials) with a neck diameter of 28 and 32 mm have a height of 5 mm (h2) and 7 mm (h3), respectively. In order to keep the residual volume of liquid that cannot be easily removed from the vial 2 as low as possible, the tip of the vial connector should only protrude as far into the interior of the vial 2 as necessary because a hollow spike or comparable piercing device protruding into the interior of the vial 2 acts like an overflow tube which only allows liquid to be withdrawn up to a liquid level at the level of the opening of the tip if the vial 2 is in the position 2 in which the bottom 22 points upwards and in which liquid is withdrawn from the vial 2. Due to the differences in the heights h1, h2 and h3, the hollow spikes or comparable piercing devices should be designed with different lengths depending on the neck diameter of the vial 2. This relationship is shown in FIG. 12. In addition, it may be useful for the liquid channel in the hollow spike or comparable piercing device to have a larger lumen if the vial is larger and therefore has a larger neck diameter because more liquid is typically withdrawn from a larger vial.

Because of this background, it may prove advantageous to offer at least the adapter of the first embodiment in several sizes, wherein a first size with a shorter hollow spike is suitable for vials with a neck diameter of, for example, 13 to 20 mm, while one or more further sizes with a longer hollow spike are suitable for larger vials (e.g. 28 and/or 32 mm).

FIG. 13 shows the coupling device 11 according to a second embodiment of the invention. The coupling device 11 has three snap hooks 111 and accordingly three first elastic elements 113; in all other respects the construction is analogous to the first embodiment.

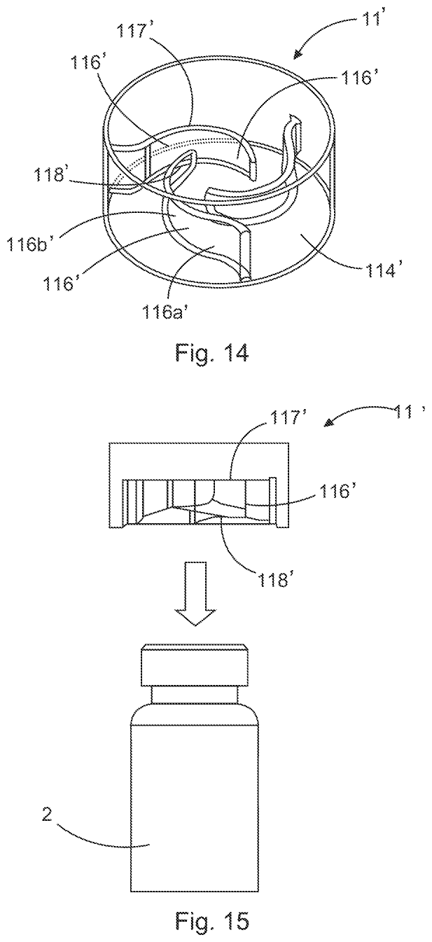

In FIG. 14, the coupling device 11′ for an adapter 1′ according to a third embodiment of the invention is shown.

Components having a function analogous to corresponding components according to the first and second embodiments are marked with the same reference sign which is marked with an apostrophe (′).

The coupling device 11′ comprises a wall 114′ surrounding an opening in which the neck 23 of the vial 2 is received when the adapter 1′ is connected to the vial 2. The wall 114′ does not need to have a closed lateral surface as shown in FIG. 14, it may for example also have clearances or consist of individual supports or the like.

At least one elastic arm 116′ is formed on the wall 114′. In the specific configuration shown in FIG. 14, three elastic arms 116′ are provided, but alternatively fewer or more than three elastic arms 116′ may be provided. The elastic arms 116′ are resilient in the radial direction, i.e. they are deflected when forces with a radial component act on the arms 116′ in the direction of the wall. This is achieved, for example, by configuring the elastic arms 116′ as flat springs which do not or not only extend in the radial direction. In the specific configuration shown in FIG. 14, the elastic arms 116′ are configured as curved flat springs. Alternatively, straight elastic arms are also possible.

The elastic arms 116′ provide an elastic structure. An elastic arm 116′ may optionally provide a first elastic element 116a′ in a first portion and a second elastic element 116b′ in a second portion 116b′.

The width or height of the elastic arms 116′, i.e. their dimension in the vertical direction, is selected to allow the elastic arms 116′ to engage the narrowed portion 232 of the neck 23 of the vial 2. In other words, the upper edge side 117′ and the lower edge side 118′ of the elastic arms 116′ serve as an engagement structure. Preferably, the lower edge side 118′ is shaped such that when the neck 23 of the vial 2 is inserted, the elastic arm 116′ slides against the upper portion 231 thereof and is pressed radially outwards such that the vial 2 and the adapter 1′ may be moved relative to each other such that the elastic arm 116′ finally engages.

In FIG. 15, the coupling device 11′ according to the third embodiment of the invention and a vial are shown in a perspective view in lateral direction. The relative movement for connecting the adapter 1′ and vial 2 is indicated by an arrow. The front part of the wall 114′ in the view is not shown in FIG. 15 such that the elastic arms 116′ are visible. In this case, by way of example, the lower edge portion 118′ formed for sliding on the upper portion 231 of the neck 23 of the vial 2 is shaped such that a portion of the elastic arm 116′ has a width decreasing towards the interior of the coupling device 11′, i.e. the elastic arm 116′ has a shape tapering towards the free end of the elastic arm 116′.

In FIG. 16A, an adapter 1′ with a coupling device 11′ according to the third embodiment is shown in a state in which it is connected to a vial 2 of a first size. In the right-hand illustration of FIG. 16A, it can be seen that the elastic arms 116′ are engaged in the narrowed portion 232 of the neck 23 of the vial 2. The vial connector 12 provides a fluid connection to the interior of the vial by penetrating its closure, which is shown in the figure as an injection stopper by way of example. In the left-hand illustration of FIG. 16A, the coupling device 11′ is shown in cross-section, the concentric circles symbolising the diameter of the upper portion 231 (outer circle), the smallest diameter in the narrowed portion 232 (middle circle) and the opening of the vial (small circle).

In FIG. 16B, the same adapter 1′ is shown in a state in which it is connected to a vial 2 of a second size. The vial of the second size has a larger neck diameter. Compared to FIG. 16A, it can be seen that the elastic arms 116′, which in turn engage in the narrowed portion 232, are deflected or deformed to a greater extent.

The adjustment of the coupling device 11′ and thus of the adapter 1′ to vials 2 with different neck diameters is achieved as described. The range of different neck diameters to which adjustment is possible may herein include all common neck diameters (typically 13 to 32 mm). This has the advantage that one adapter 1′ may be used for all vials.

However, as described in the first embodiment, it is also possible to provide adjustability only for a smaller range of neck diameters, for example in such a way that one adapter 1′ is suitable for neck diameters from 13 to 20 mm, while for larger neck diameters at least one further adapter is required, which in turn may be adjustable to different neck diameters.

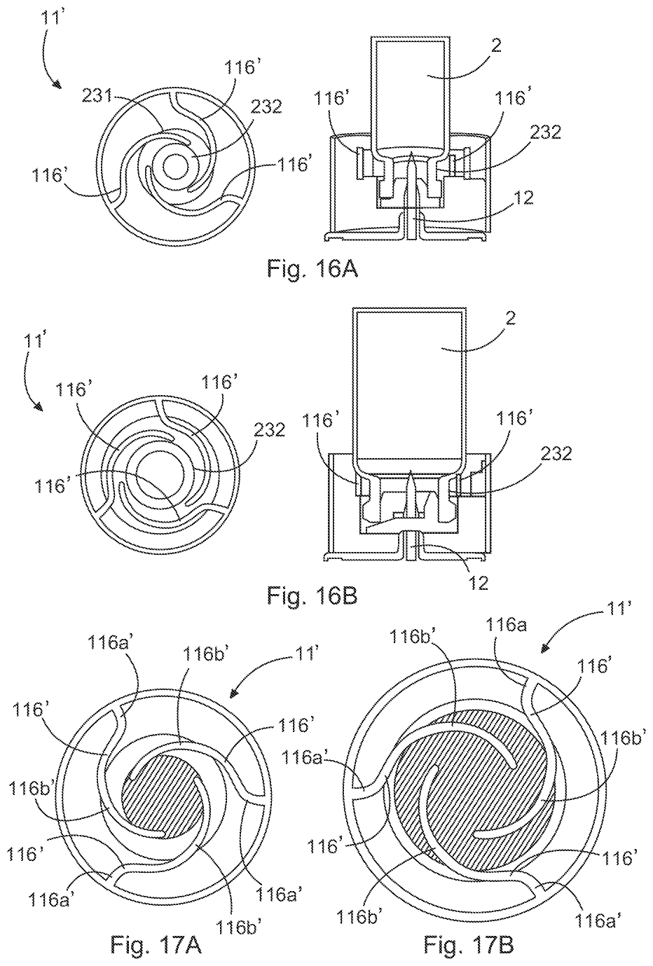

By way of example, two sizes of coupling device 11′ are shown in cross-section in FIGS. 17A and 17B, the size shown in FIG. 17A being suitable for vials 2 with a neck diameter of 13 to 20 mm and the size shown in FIG. 17B being suitable for vials 2 with a neck diameter of 28 to 32 mm. These diameters are drawn in the form of concentric circles in FIGS. 17A and 17B. The coupling device 11′ shown in FIGS. 17A and 17B is not connected to a vial 2 such that the arms 116′ are in their neutral position.

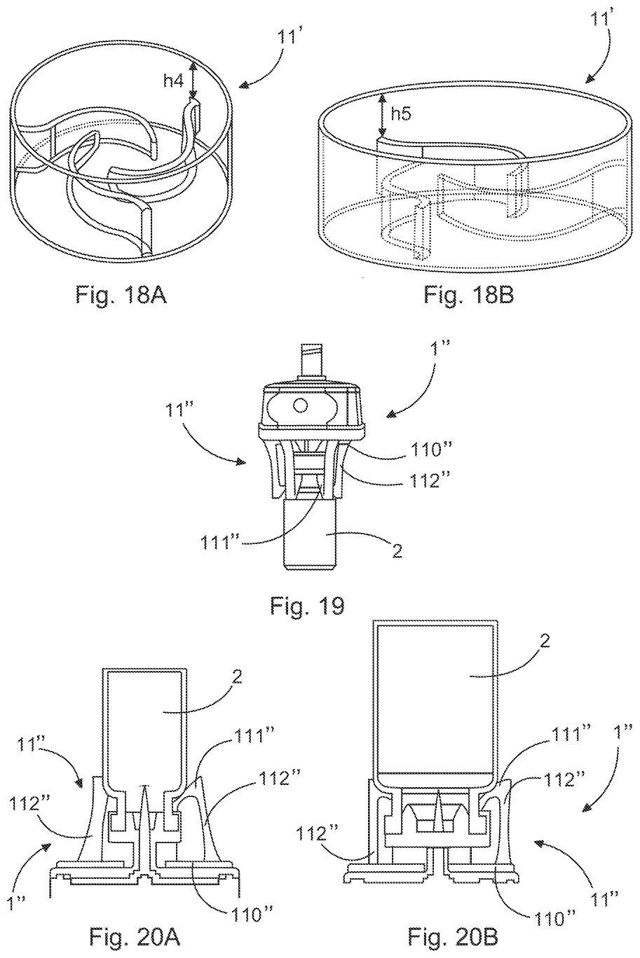

As described with respect to the first embodiment, in order to reduce the residual volume, it may be convenient to provide different versions of the coupling device 11′ of the adapter 1′ for smaller vials 2 (e.g. 13 to 20 mm) and larger vials 2 (e.g. 28 to 32 mm), in order to prevent the hollow spike 12 or a corresponding piercing device from protruding further into the interior thereof than required in the case of smaller vials 2. This is achieved, for example, by choosing the height h4, h5 of the area of the wall 114′ that lies above the elastic arms 116′ to be smaller (h4) in the case of a coupling device 11′ for smaller vials 2 than in the case of an adapter 1′ for larger vials 2 (h5), for the same length of the hollow spike 12. This is shown in the form of the comparison of FIGS. 18A and 18B.

In FIG. 19, an adapter 1″ with a coupling device 11″ according to a fourth embodiment of the invention is shown.

Components having a function analogous to corresponding components according to the first, second and third embodiments are marked with the same reference sign which is marked with a double apostrophe (″).

The coupling device 11″ according to the fourth embodiment comprises snap hooks 111″, which are arranged at the free end of cantilever arms 112″. The cantilevers 112″ herein provide the elastic structure for adjusting the coupling device 11″ to different sizes of the vial, i.e. they are in this way elastically deformable. A cantilever 112″ may optionally provide a first elastic member in a first portion and a second elastic member in a second portion.

In FIG. 20A, the adapter 1″ is shown in a state in which it is connected to a vial 2 of a first size. In FIG. 20B, the same adapter 1″ is shown in a state in which it is connected to a vial 2 of a second size. Herein, the vial 2 of the second size has a larger neck diameter. Compared to FIG. 20A, it can be seen that the elastic cantilever arms 112″ are more deflected or deformed.

In the described manner, the adjustment of the coupling device 11″ and thus of the adapter 1″ to vials 2 with different neck diameters is achieved. The range of different neck diameters to which adjustment is possible can herein include all common neck diameters (typically 13 to 32 mm). This has the advantage that one adapter 1″ may be used for all vials.

However, as described for the first and third embodiments, it is also possible to provide adjustability only for a smaller range of neck diameters, for example such that one adapter 1″ is suitable for neck diameters from 13 to 20 mm, while for larger neck diameters at least one further adapter is required, which in turn may be adjustable to different neck diameters.

FIGS. 19, 20A and 20B show an example of a coupling device 11″ with five cantilevers 112″. However, more or less than five cantilevers 112″ may also be used.

With the different embodiments of the coupling device according to the invention, different embodiments of the adapter 1, 1′, 1″ according to the invention result.

The adapter 1, 1′, 1″ according to the embodiments shown above has a hollow spike 12 as a vial connector. The hollow spike 12 serves to be pierced through the septum 24 (or through an alternative pierceable vial closure) with its tip 121 such that the opening of the liquid channel arranged inside the hollow spike 12 located at the tip 121 protrudes into the interior of the vial 2.

It is possible that the hollow spike 12 comprises one or more further fluid channels. A further fluid channel may, for example, serve to ventilate the vial 2 to equalise the pressure when withdrawing a liquid.

The adapter 1, 1′, 1″ further comprises a fluid connector 13 configured to provide a fluid connection between a fluid device (not part of the adapter 1, 1′, 1″ and not shown in the figures) and the adapter 1, 1′, 1″ such that a fluid connection is provided between the interior of the vial 2 connected to the adapter 1, 1′, 1″ and the fluid device.

The fluid connector 13 comprises at least one port 131 in fluid connection with the vial connector 12 such that a fluid, for example a liquid, can flow from the interior of the vial 2 to the port 131. A port 131 provides a connection site for a fluid device to provide a fluid connection between the interior of the vial 2 connected to the adapter 1, 1′, 1″ and the fluid device. By means of the fluid device, a liquid may be withdrawn from or supplied to the interior of the vial 2. For example, the fluid device may be: a hypodermic syringe without an attached hypodermic needle, a hypodermic syringe with an attached hypodermic needle, another fluid container, a tube connector, etc.

In the embodiments shown in FIGS. 5, 6, 16 and 19, the fluid connector 13 comprises a port 131, namely a port 131 in the form of a female Luer cone.

In other embodiments not shown in the figures, the fluid connector 13 comprises more than one port.

Optionally, the fluid connector 13 may comprise a pressure equalisation device 132 as shown in FIGS. 5 and 6. In this case, the pressure equalisation device 132 is preferably configured in such a way that no potentially harmful substances can enter the environment from the fluid system through the pressure equalisation device 132. This is realised, for example, by a filter device.

Optionally, the fluid connector 13 may comprise a filter 122 for the liquid and/or a vent filter 133, as shown in FIGS. 5 and 6.

The adapter 1, 1′, 1″ may comprise other components in addition to those mentioned, for example a cover for a port 131 of the fluid connector 13.

In the embodiments shown in FIGS. 5, 6, 16 and 19, the vial connector 12 and the fluid connector 13 are connected to each other, for example by adhesive bonding and/or welding, in particular ultrasonic welding. In other embodiments, the vial connector 12 and the fluid connector 13 are formed integrally.

For example, the vial connector 12 and the fluid connector 13 may be configured together in the form of a withdrawal spike. A typical withdrawal spike for a medical fluid transfer system for withdrawing medical liquids from medical containers such as vials usually comprises a hollow spike for piercing a septum or stopper, the hollow spike comprising a liquid channel and a vent channel. The vent channel may herein open into an optional vent filter. The liquid channel may herein open into an optional liquid filter. An example of a preferred withdrawal spike is described and shown in EP 1 192 927 A2.

In the embodiments shown in FIGS. 5, 6, 16 and 19, the coupling device 11 and the unit comprising the vial connector 12 and the fluid connector 13 are connected to each other, for example by adhesive bonding and/or welding, in particular ultrasonic welding.

In other embodiments not shown in the figures, the coupling device 11 is formed integrally with the vial connector 12 or the fluid connector 13 and the third of said components is connected thereto, for example by adhesive bonding and/or welding, in particular ultrasonic welding.

In other embodiments not shown in the figures, all three components, i.e. coupling device 11, vial connector 12 and fluid connector 13, are formed integrally.

Preferably, the components of the adapter of the embodiments described above and other embodiments comprise a polymer, more preferably they are made substantially or entirely of a polymer.

Herein, it is particularly preferred that the coupling device 11, 11′, 11″ comprises a polymer, preferably it is made substantially or entirely of a polymer, since in this way the required elastic properties may be provided in a simple manner.

Herein, it is further preferred that at least the coupling device 11, 11′, 11″ is manufactured as a monolithic element, further preferably by injection moulding of a plastic material.

In the embodiments of the invention described above and further embodiments, the coupling device 11, 11′, 11″ is preferably configured such that the adapter may be connected to a vial 2 in accordance with the standard ISO 8362-1 or the standard ISO 8536-1.

Herein, further preferably, the coupling device 11, 11′, 11″ is adjustable by the elastic structure to at least two of the group of different diameters of the vial consisting of 13 mm, 20 mm, 28 mm and 32 mm, in particular to the diameters 13 mm and 20 mm or to the diameters 28 mm and 32 mm.

In the embodiments of the invention described above and in further embodiments, the coupling device is configured to irreversibly connect the adapter to the vial.

In accordance with the invention, preferably, the adjustment may be carried out continuously, i.e. the coupling device is suitable not only for vials with the specifically mentioned diameters, but for all diameters of a range containing the specifically mentioned values, for example 10 mm to 35 mm or 10 mm to 23 mm or 27 mm to 33 mm.

The set according to the invention comprises a first adapter according to an embodiment of the invention described above or another embodiment of the invention, and a second adapter for a vial for a medical liquid.

The first and the second adapter are configured for different sizes or size ranges of the vials, i.e. the second adapter is at least also suitable for vial sizes to which the coupling device of the first adapter cannot be adjusted.

Preferably, the second adapter is also an adapter according to an embodiment of the invention described above or another embodiment of the invention. The different sizes of vial to which the coupling device of the second adapter is adjustable in this case are at least partially different from the different sizes of vial to which the coupling device of the first adapter is adjustable.

The system according to the invention comprises an adapter according to an embodiment of the invention described above or another embodiment of the invention, or a set according to the invention comprising a plurality of adapters, and a fluid device. The system according to the invention offers, for example, the advantage that an adapter suitable for a fluid device, for 30 example a hypodermic syringe, is provided which may be used for vials of different sizes.

1. A coupling device for an adapter for a vial for a medical liquid,
wherein the coupling device is configured to connect the adapter to the vial, and
wherein the coupling device comprises an elastic structure for adjusting the adapter to accommodate different vial sizes.

2. The coupling device according to claim 1,
wherein the elastic structure comprises:
a first elastic element connected to a base body of the coupling device, the first elastic element being elastically adjustable to accommodate different vial sizes, and
a second elastic element connected to the first elastic element and configured to hold the vial.

3. The coupling device according to claim 1,
further comprising an engagement structure configured to lock on the vial when connecting the vial to the adapter.

4. The coupling device according to claim 3,
wherein the engagement structure is elastically supported by the first elastic element for adjusting the coupling device to different vial sizes, and/or
wherein the first elastic element is configured to store a restoring force when the first elastic element is deflected from a rest position, the restoring force comprising a radial force component with respect to a diameter of a neck of the vial, and/or
wherein the engagement structure comprises a resilient cantilever comprising the first elastic element.

5. (canceled)

6. The coupling device according to claim 1,
wherein the engagement structure comprises at least one elastic arm being resilient in a direction that is radial with respect to a diameter of a neck of the vial.

7. The coupling device according to claim 6,
wherein the at least one elastic arm has a surface that is an upper surface with respect to a longitudinal direction which corresponds to a direction from a bottom to the neck of the vial when the coupling device is connected to the vial, which upper surface is configured to engage in a narrowed portion in a region of the neck of the vial when the vial is connected to the adapter, and/or
wherein the elastic arm has a surface that is a lower surface with respect to a longitudinal direction which corresponds to a direction from the bottom to the neck of the vial when the coupling device is connected to the vial, the lower surface configured to engage in the narrowed portion in the region of the neck of the vial when the vial is connected to the adapter.

8. The coupling device according to claim 6,
wherein the at least one elastic arm has a surface that is a lower surface with respect to a longitudinal direction corresponding to a direction from the bottom to the neck of the vial when the coupling device is connected to the vial, the lower surface configured to elastically deform the at least one elastic arm when the vial is connected to the adapter by sliding on a surface portion of the vial until the elastic arm engages the vial.

9. The coupling device according to claim 1,
wherein the coupling device is configured to connect the adapter to a vial according to standard ISO 8362-1 or standard ISO 8536-1.

10. The coupling device according to claim 1,
wherein the coupling device is adjustable by the elastic structure to accommodate at least two different diameters of a neck of the vial, the at least two diameters selected from the group consisting of 13 mm, 20 mm, 28 mm and 32 mm.

11. The coupling device according to claim 1,
wherein the coupling device is continuously adjustable by the elastic structure to accommodate a range of diameters of a neck of the vial,
wherein the range is 10 mm to 35 mm.

12. An adapter for a vial for a medical liquid, the adapter comprising:
a coupling device according to claim 1;
a vial connector configured to provide a first fluid connection between an interior of a vial and the adapter; and
a fluid connector configured to provide a second fluid connection between a fluid device and the adapter such that a fluid connection is provided between the interior of the vial and the fluid device.

13. The adapter according to claim 12,
wherein the fluid connector comprises a plug-in connection element in order to provide the second fluid connection between the fluid device and the adapter, and/or
wherein the vial connector comprises a piercing device in order to provide the first fluid connection between the interior of the vial and the adapter,
wherein the piercing device is configured to pierce a septum or an injection stopper of the vial in order to provide the first fluid connection between the interior of the vial and the adapter.

14. A set comprising:
the adapter according to claim 12; and
a second adapter for a vial for a medical liquid,
wherein the adapter and the second adapter are configured to accommodate different vial sizes.

15. (canceled)

16. The coupling device according to claim 3, wherein the engagement structure is configured to lock on the vial in a narrowed portion in a region of a neck of the vial.

17. The coupling device according to claim 4, wherein the first elastic element comprises a curved flat spring.

18. The coupling device according to claim 6, wherein the at least one elastic arm comprises a flat spring.

19. The coupling device according to claim 10, wherein:
the at least two different diameters are 13 mm and 20 mm, or
the at least two different diameters are 28 mm and 32 mm.

20. The coupling device according to claim 13, wherein the fluid connector comprises a Luer cone.

21. The coupling device according to claim 13, wherein the vial connector comprises a withdrawal spike for a medical fluid transfer system.

22. The set according to claim 14, wherein:
the second adapter is identical to the adapter,
the adapter is adjustable to accommodate a first range of vial sizes, and
the second adapter is adjustable to accommodate a second range of vial sizes that is different from the first range of vial sizes.
